(19) United States
(12) Patent Application Publication
(10) Pub. No.: US 2014/0335279 A1
(43) Pub. Date: Nov. 13, 2014

(54) METHOD AND APPARATUS FOR COLOR CODING A TOOL BIT

(71) Applicant: Shao-Hsien Hsu, Taichung City (TW)

(72) Inventor: Shao-Hsien Hsu, Taichung City (TW)

(21) Appl. No.: 14/337,246

(22) Filed: Jul. 22, 2014

Related U.S. Application Data
(63) Continuation-in-part of application No. 13/555,188, filed on Jul. 22, 2012.
Application No. 13/555,188 is a continuation-in-part of application No. 13/192,477, filed on Jul. 28, 2011, now abandoned.
Application No. 13/192,477 is a division of application No. 12/395,680, filed on Mar. 1, 2009, now abandoned.

(51) Int. Cl. B05C 1/02

(52) U.S. Cl. CPC B05C 1/027
USPC 427/429

(57) ABSTRACT

A method for color coding a tool bit includes the following steps: Firstly, a hexagon receptacle is defined in one end of a shaft of a motor. Then, a tool bit to be colored is inserted into the hexagon receptacle of the shaft of the motor in a coaxial manner. A pneumatic device is utilized to have dyestuff injected from a paint reservoir to a brush. The paint reservoir and the brush then move together with respect to the motor to have the brush in contact with a side surface of the tool bit. And, the motor is turned on to rotate the tool bit so as to have the tool bit be annularly colored by the brush. Upon finished coloring, the paint reservoir and the brush together are returned back to their original positions and the motor is turned off. Finally, the colored tool bit can be removed off the shaft of the motor.

### CROSS-REFERENCE TO RELATED APPLICATION

This is a continuation-in-part of the co-pending application Ser. No. 13/555,188, filed on Jul. 22, 2012, which is a continuation-in-part of application Ser. No. 13/192,477, filed on Jul. 28, 2011, now abandoned.

### BACKGROUND OF THE INVENTION

1. Field of the Invention

The present invention relates to a method and apparatus for color coding a tool bit, and more particularly to a method and apparatus for color coding a tool bit by painting.

2. Description of Related Art

A conventional recognizable tool bit includes a head, a neck connected to the head, and an inserter connected to the neck. An aluminum-alloy recognizable ring is sleeved on the neck. The recognizable ring has an outer periphery protruding from the neck. A color of the recognizable ring is provided for recognizing a standard of the tool bit.

The conventional recognizable tool bit provides a recognizable effect for a user to easily recognize the standard of the tool bit during operation. However, it is inconvenient to sleeve the recognizable ring on the neck of the tool bit. Furthermore, the aluminum-alloy recognizable ring increase the production cost.

In addition, the conventional apparatus for coloring tools often has a lever or a steering wheel for an operator to start/stop the coloring process by hands. Nevertheless, it is inefficient in the assembling line and it also reduces the quality of the products because the operator cannot use two hands to control the apparatus and to collect the finished products at the same time.

The present invention has arisen to mitigate and/or obviate the disadvantages of the conventional recognizable tool bit.

### SUMMARY OF THE INVENTION

Briefly described, a method for color coding a tool bit for recognition in accordance with the present invention comprises the steps of a). defining a hexagon receptacle in one end of a shaft of a motor; b). inserting a tool bit into the hexagon receptacle of the shaft of the motor in a coaxial manner; c). providing a paint reservoir, a pneumatic device connected to the paint reservoir for ejecting dyestuff from the paint reservoir, and a brush arranged below the paint reservoir to absorb dyestuff from the paint reservoir; d). moving the paint reservoir and the brush together with respect to the motor to have the brush in contact with a side surface of the tool bit; e). turning on the motor to rotate the tool bit so as to have the tool bit be annularly colored by the brush; f). upon finished coloring, returning the paint reservoir and the brush together back to their original positions and turning off the motor; and g). removing the tool bit from the hexagon receptacle of the shaft of the motor.

In a presently preferred embodiment of the invention, the steps (d) and (e) are actuated by a pedal-type switch. And, before the step (e), the method further comprises the following steps: setting a contact time for the brush to stay in contact with the tool bit on the shaft of the motor; setting an injection time of the dyestuff from the paint reservoir to the brush; and setting a rotating time of the motor.

Preferably, the method further comprises the step of providing a lifting mechanism so that the lifting mechanism can be operated to lower the paint reservoir and the brush to a lower position to have the brush in contact with the tool bit as in step (d), and lift the paint reservoir and the brush back to their upper original position as in step (f).

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an apparatus for color coding a tool bit in accordance with the present invention;

FIG. 2 is a side view of the apparatus shown in FIG. 1;

FIG. 3 is a view similar to FIG. 2, illustrating the motion of a lifting mechanism of the apparatus;

FIG. 4 is a partial enlarged view of the apparatus in FIG. 3, illustrating the rotation of a shaft of a motor of the apparatus; and

FIG. 5 is a perspective view of a recognizable tool bit colored by the apparatus in accordance with the present invention.

### DETAILED DESCRIPTION OF EMBODIMENTS

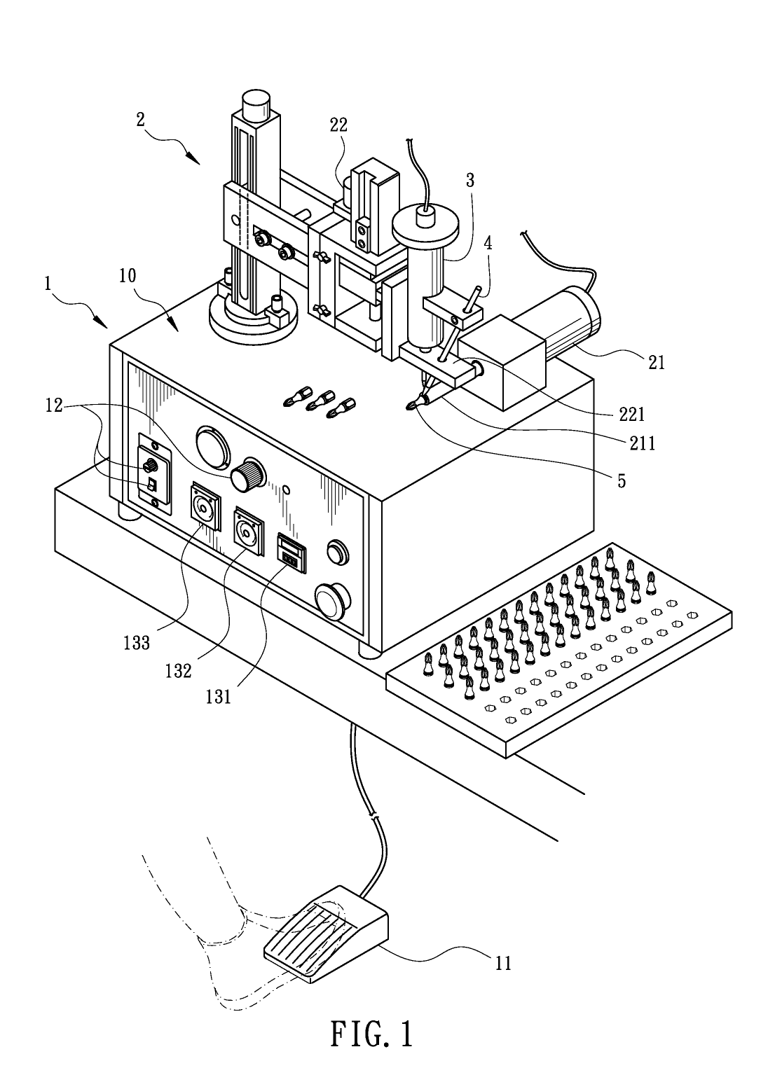

Referring to the drawings and initially to FIGS. 1-5, an apparatus for color coding a tool bit 5 for recognition in accordance with the preferred embodiment of the present invention comprises a control unit 1 and a decorating unit 2 mounted on an upper platform 10 of the control unit 1. The control unit 1 is electrically connected to the decorating unit 2 for control motion of the decorating unit 2.

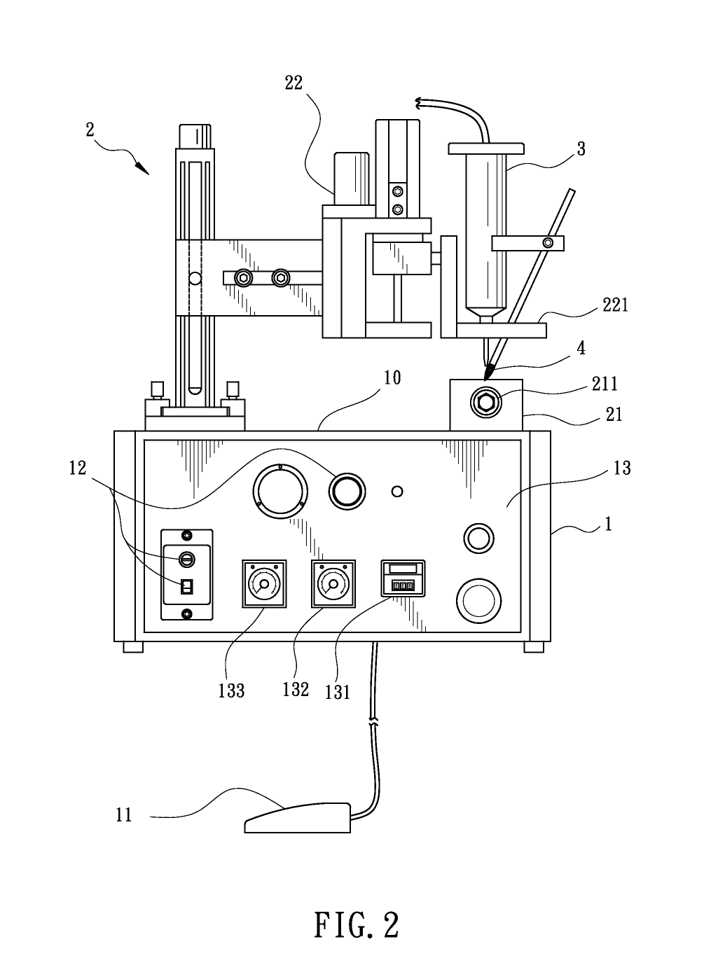

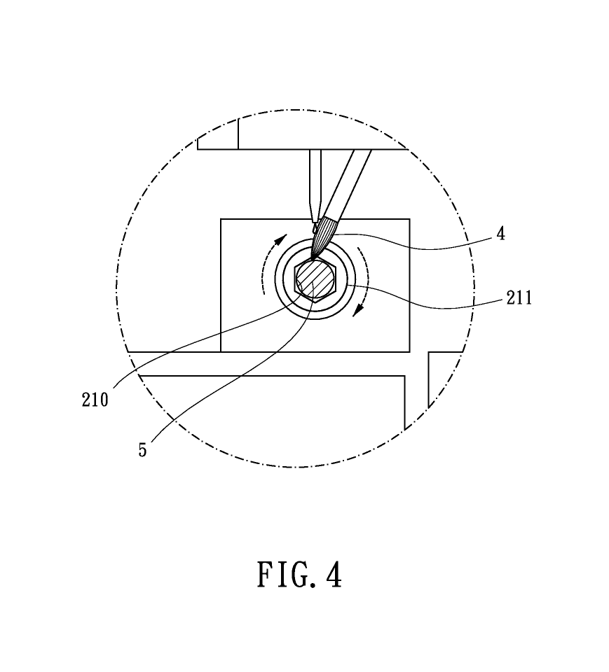

As shown in FIGS. 1 and 2, the decorating unit 2 includes a motor 21, a lifting mechanism 22 mounted adjacent to the motor 21, a paint supply device 3 and a brush 4, wherein the paint supply device 3 and a brush 4 are mounted on the lifting mechanism 22. Specifically, the paint supply device 3 and the brush 4 are both mounted on a bracket 221 of the lifting mechanism 22 so that the paint supply device 3 and the brush 4 can be lifted up and down together by the lifting mechanism 22. The motor 21 has a shaft 211. The shaft 211 is formed on a distal end with a hexagon receptacle 210, as best seen in FIG. 4, to receive the tool bit 5 inserted in an axial direction of the hexagon receptacle 210. The paint supply device 3 includes a paint reservoir 3 and a pneumatic device (not shown) connected to the paint reservoir 3 for ejecting dyestuff from the paint reservoir 3 to the brush 4. The brush 4 then absorbs the dyestuff and transfers the same an outer periphery of the tool bit 5.

The control unit 1 has a pedal-type switch 11 and a panel 13. The panel 13 is provided thereon with a supplying counter display 131, a contacting counter display 132, a rotating counter display 133 and a set of control knobs 12. The switch 11 is provided for turning on the decorating unit 2. The supplying counter display 131 is provided for showing an ejecting time for which the pneumatic device ejects the dyestuff from the paint reservoir 3 into the brush 4. The contacting counter display 132 is provided for showing a contact time for which the brush 4 contacts with the tool bit 5. The rotating counter display 133 is provided for showing a rotating time for which the motor 21 drives the tool bit 5 to rotate with the shaft 211. The set of the control knobs 12 is provided for adjusting the aforementioned ejecting time, the contact time as well as the rotating time in order to control a thickness of a colored layer of the tool bit 5.

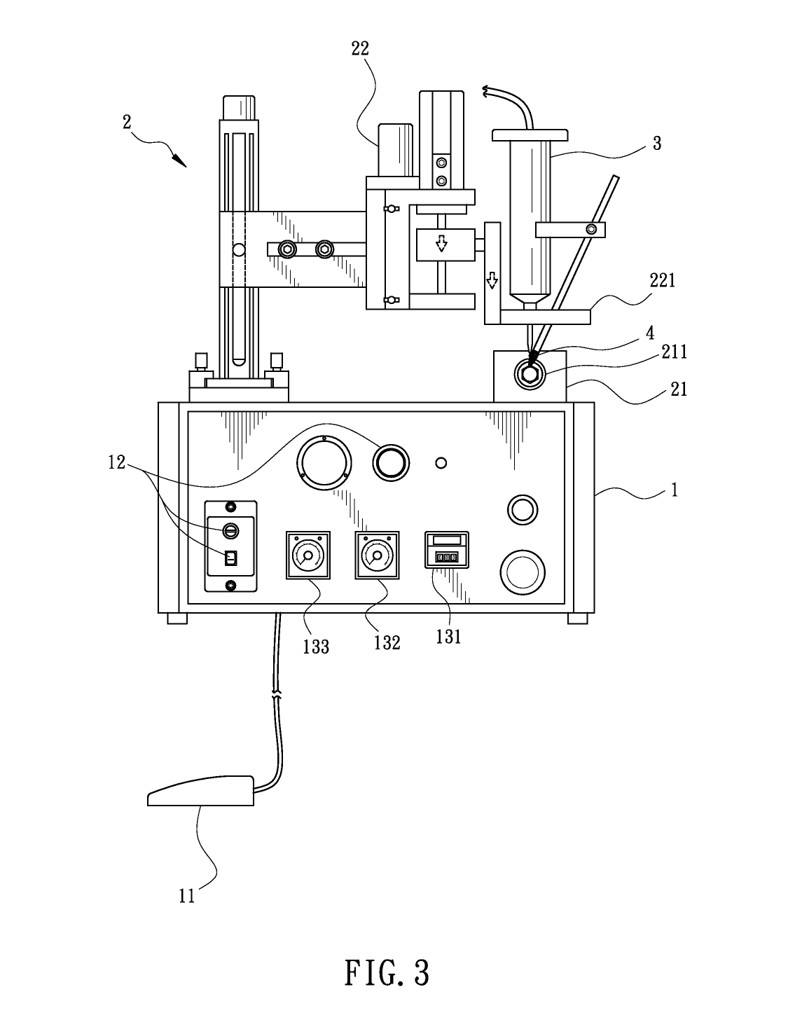

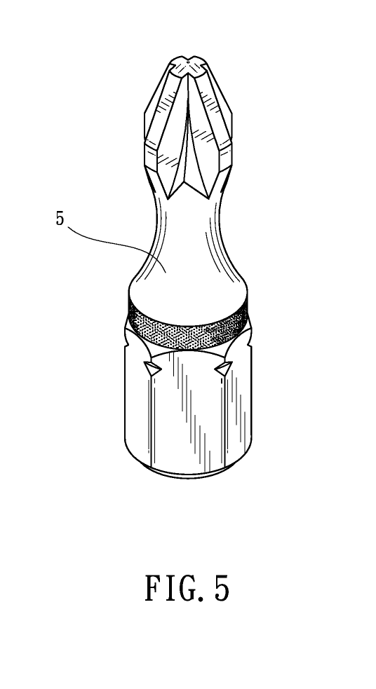

In operation, the tool bit 5 is inserted and positioned in the hexagon receptacle 210 of the shaft 211 of the motor 21 in a coaxial manner. The control knobs 12 are adjusted to determine the flow rate or the ejecting time of the dyestuff, the contact time, and the number of cycles of the shaft 211. An operator then pedals the pedal-type switch 11 to turned on the decorating unit 2. At this time, the shaft 211 of the motor 21 rotates the tool bit 5. The lifting mechanism 22 carries the paint supply device 3 and the brush 4 from an upper position (see FIG. 2) to a lower position (see FIG. 3) to have the brush 4 in contact with the tool bit 5. The paint supply device 3 injects the dyestuff in the brush 4. Since the brush 4 of the bracket 221 contacts with the tool bit 5, which is rotated by the motor 21, the tool bit 5 is annularly colored, as shown on FIGS. 4 and 5.

As shown above, the operator only pedals the pedal-type switch 11 to start coloring the tool bit 5 so that the operator can further use two hands to position the next tool bit 5 or to collect finished tool bits 5 sequentially, as shown in FIG. 1. It is understood that, upon the contact time is finished, the lifting mechanism 22 moves the bracket 221 and the paint supply device 3 back to the upper position, as shown in FIG. 2, to detach the brush 4 from the tool bit 5. The pneumatic device stops ejecting the dyestuff from the paint reservoir 3 upon the ejecting time is finished. And, upon the rotating time is finished, the rotation of the shaft 211 of the motor 21 is stopped. The colored tool bit 5 can be removed from the shaft 211 of the motor 21.

What is claimed is:

1. A method for color coding a tool bit, comprising:
(a). defining a hexagon receptacle in one end of a shaft of a motor;
(b). inserting a tool bit into the hexagon receptacle of the shaft of the motor in a coaxial manner;
(c). providing a paint reservoir, a pneumatic device connected to the paint reservoir for ejecting dyestuff from the paint reservoir, and a brush arranged below the paint reservoir to absorb dyestuff from the paint reservoir;
(d). moving the paint reservoir and the brush together with respect to the motor to have the brush in contact with a side surface of the tool bit;
(e). turning on the motor to rotate the tool bit so as to have the tool bit be annularly colored by the brush;
(f). upon finished coloring, returning the paint reservoir and the brush together back to their original positions and turning off the motor; and
(g). removing the tool bit from the hexagon receptacle of the shaft of the motor.

2. The method as claimed in claim 1, wherein the steps (d) and (e) are actuated by a pedal-type switch.

3. The method as claimed in claim 2, further comprising, before the step (e), the following steps:
setting a contact time for the brush to stay in contact with the tool bit on the shaft of the motor;
setting an injection time of the dyestuff from the paint reservoir to the brush; and
setting a rotating time of the motor.

4. The method as claimed in claim 3, further comprising the step of providing a lifting mechanism as such that, in step (d), the lifting mechanism lowers the paint reservoir and the brush together to a lower position to have the brush in contact with the tool bit, and, in step (f), the lifting mechanism lifts the paint reservoir and the brush together back to their upper original position.
